(19) United States
(12) Patent Application Publication
(10) Pub. No.: US 2015/0234092 A1
(43) Pub. Date: Aug. 20, 2015

(54) Method for Determining a Weight-adjusting Parameter in a Variable-weight Vulnerability Assessment Method for Water-outburst From Coal Seam Floor

(71) Applicant: CHINA UNIVERSITY OF MINING AND TECHNOLOGY, BEIJING, Beijing (CN)

(72) Inventors: Qiang WU, Beijing (CN); Bo LI, Beijing (CN); Shouqiang LIU, Beijing (CN); Yifan ZENG, Beijing (CN)

(73) Assignee: CHINA UNIVERSITY OF MINING AND TECHNOLOGY, BEIJING, Beijing (CN)

(21) Appl. No.: 14/622,143

(22) Filed: Feb. 13, 2015

(30) Foreign Application Priority Data
Feb. 18, 2014 (CN) 201410055096.1

(51) Int. Cl. G01V 99/00; G06F 17/10; G06F 17/50

(52) U.S. Cl. CPC G01V 99/005; G06F 17/5009; G06F 17/10

(57) ABSTRACT

A method for determining a weight-adjusting parameter in a variable-weight vulnerability assessment method for water-outburst from coal seam floor, comprising the steps of determining a dominant factors and a constant-weight weighting value, further comprising the following steps: 1) building a state variable-weight vector formula; 2) selecting or giving an assessment unit in accordance with constraint conditions; 3) determining an optimum variable-weight weighting value of the selected assessment unit; and 4) solving a value of the weight-adjusting parameter according to a parameter solving model. The method for determining a weight-adjusting parameter in assessment and prediction of vulnerability for water-outburst from coal seam floor by means of a variable-weight model is proposed at the first time. In this method, an optimum variable-weight weighting value of the selected assessment unit is set, and then a value of the weight-adjusting parameter is solved according to a built parameter solving model. With practical application testing, the weight-adjusting parameter determined by this method can effectively reflect the controlling effects on water-outburst of the multiple dominant factor index values in various combined states, and can effectively improve the precision of assessment and prediction of vulnerability for water-outburst from coal seam floor.

### CROSS-REFERENCE TO RELATED APPLICATIONS

This application claims the benefit of Chinese Patent Application No. 201410055096.1, filed Feb. 18, 2014, the entire content of which is hereby incorporated herein by reference.

### FIELD OF THE INVENTION

The present invention relates to a method for determining a parameter in vulnerability assessment for water-outburst from coal seam floor, and specifically to a method for determining a weight-adjusting parameter in a variable-weight vulnerability assessment for water-outburst from coal seam floor based on a variable-weight model.

### BACKGROUND OF THE INVENTION

It is an important guarantee of energy safety for the safe and efficient mining to coal resource. However, due to the sophisticated hydrogeological condition, the mine water disasters especially the water-outburst from coal seam floor cause serious threats to coal mining in China, which is a threat to about 27% of total proven coal reserves in China. There are about 16 billion tons of coal reserves facing the threat by water-outburst from coal seam floor in North China. In addition, in recent years, since the coal mining is developed to deeper areas, some old mining districts have a mining depth over 1000 m, thus forming a high geological stress region in deep mining area. Further, since the floor of the mining coal seam has to bear an even larger water pressure by the karst pressure aquifer, the possibility of water-outburst is substantially higher and the accidents of mine flooding due to water-outburst increase annually, thereby seriously limiting the coal mining in China. Therefore, it is practically meaningful for healthy and stable development of national economy to employ effective prevention measures to release the coal reserves facing a water disaster threat and protect safety production of coal mines.

Water-outburst from coal seam floor is an underground rock mass failure phenomenon and is a nonlinear dynamic phenomenon controlled by various influencing factors and having very complicated generation mechanism, wherein the human-related mining engineering activities cause stress field energy release of the rock mass surrounding the coal seam, the rock structure of the coal seam floor aquifuge is damaged, and the local water charge in mines results in a sudden change in hydrogeological condition. As the modern mathematics cannot use a definite mathematic formula to describe in detail the nonlinear dynamic phenomenon which has a complicated mechanism and is controlled by many factors, the models based completely or partially on experiences or on statistics are main ways for describing such nonlinear dynamic phenomenon. For example, the water-outburst coefficient evaluation method proposed in the hydrogeology conference of Jiaozuo mining district in 1964, which used the theory of relative coefficients (the ratio of aquifuge thickness to water pressure) by Vague Forrence from Hungary for reference, is simple in physical concept, convenient in calculation, easy in on-spot operation, and thus is the main method for water-outburst from coal seam floor assessment in China for years. However, this method considers only two influencing factors for controlling floor water-outburst, i.e. the water pressure of water charge aquifer and the thickness of aquifuge rock zone of coal seam floor. Though some modifications were made thereto for improvement, it still considers only these two controlling factors and the serious defects remain, such as lacking consideration of influencing “weighting”. Apparently, the factors for controlling water-outburst under consideration in this method are quite limited. It cannot describe the water-outburst from coal seam floor which is a nonlinear dynamic phenomenon controlled by various factors and having very complicated mechanism, deflects the very complicated water-outburst mechanism of coal seam floor, and thus is not suitable for new mining methods and the water-outburst from coal seam floor assessment under new geological environment condition.

In order to solve the hard problems of prediction and assessment for water-outburst from coal seam floor, one of the inventors of the present invention, Professor WU Qiang from China University of Mining & Technology (Beijing), devotes himself to research based on the multiple source information integration theory and the “loop theory”, and uses an integral technology of geological information system (GIS), which has powerful statistic analysis and processing functions for spatial data, with linear or nonlinear mathematical methods to conduct a research to water-outburst from coal seam floor, and systematically established a dominant indexing system for water-outburst from floor in 2007 which can completely and truly reflect the complicated mechanism of water-outburst from coal seam floor and its evolution process, wherein the acting manners and features of various water-outburst dominant factors in the system during water-outburst are described in detail. However, such detailed and systematic analysis and determination of dominant factors for controlling water-outburst from coal seam floor to correctly establish a physical concept model for water-outburst from coal seam floor is just the first step for solving the hard problem of prediction and assessment for water-outburst from floor. In 2009, a mathematic model and an assessment method for water-outburst from coal seam floor were proposed which can truly describe the nonlinear dynamic phenomenon controlled by various influencing factors and having very complicated generation mechanism. The mathematic model and the assessment method, during practical application of on-spot engineering, are clear in concept, simple and practical in calculation process, easy for on-spot engineering technicians to master, which is a modern and advanced mathematic model and assessment method, convenient for operation, and completed the second and third steps for systematically solving the hard problem of prediction and evaluation for water-outburst from coal seam floor. It truly reflects the water-outburst from coal seam floor controlled by various influencing factors and having very complicated mechanism and evolution process, and appropriately solves the hard problem of prediction for water-outburst from coal seam floor.

The prior vulnerability indexing method has the following defects: the “weighting” of various dominant factors is determined by an information combination method, and once the “weighting” is determined, the weighting values will be constant in the whole research area no matter how the index values of the dominant factors are changed in the research area and how serious the sudden change is. That is, the prior vulnerability indexing evaluation method for water-outburst from coal seam floor uses a “constant weight weighting” model based on the information combination method. Such “constant weight weighting” model for water-outburst vulnerability assessment based on the information combination method can not describe the controlling and influencing features of the individual dominant factors to water-outburst from coal seam floor due to a sudden change of their index values caused by a change in the hydrogeological condition in the research area, can not reveal any “encouraging” and “punishing” mechanism with the control and influence of the dominant factors to water-outburst from coal seam floor due to a sudden change of their index values in the research area, and can not reflect the relative importance and preferences as well as the controlling and influencing effects on water-outburst of the multiple dominant factors in various combined states.

With long time of research and practice, the inventors of the present invention recently proposed a method for making prediction and assessment for water-outburst from coal seam floor by means of a vulnerability indexing method based on a variable weight model. The method for making prediction and assessment to water-outburst from coal seam floor by means of a vulnerability indexing method based on a variable weight model, compared with the prior assessment method based on the constant weight model, can overcome the defect of the assessment based on the constant weight model that each factor has only one constant weighting value, can effectively describe the controlling and influencing features of the individual dominant factors to water-outburst from coal seam floor due to a sudden change of their index values caused by a change in the hydrogeological condition in the research area, and can reflect the relative importance and preferences as well as the controlling and influencing effects on water-outburst of the multiple dominant factors in various combined states.

However, in prediction and assessment to water-outburst from coal seam floor by means of the variable weight model, a key step for forming a state variable weight vector is determining weight adjusting parameters in the model. These parameters can control and adjust the variable weight weighting effects, thus enabling respective “punishing” and “encouraging” effects. However, it is difficult in this technology to determine the weight adjusting parameters in the variable weight model, and now there is no uniform method for analysis and determination.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

The objectives of the present invention are to provide a method for determining a weight-adjusting parameter in a variable-weight vulnerability assessment method for water-outburst from coal seam floor based on a variable weight model to systematically solve the key problem of predicting water-outburst by means of a variable weight model, and thus satisfying the requirements of coal industry and improving the prior art.

In order to achieve the objectives, the present invention provides a method for determining a weight-adjusting parameter in a variable-weight vulnerability assessment method for water-outburst from coal seam floor comprising determination of dominant factors and constant-weight weighting value, and further comprising the following steps:

1. building a state variable-weight vector formula;
2. selecting or giving an assessment unit in accordance with constraint conditions;
3. determining an optimum variable-weight weighting value of the selected assessment unit; and
4. solving a value of the weight-adjusting parameter according to a parameter solving model.

With the above method for determining a weight-adjusting parameter in a variable-weight vulnerability assessment method for water-outburst from coal seam floor, the present invention has the following beneficial effects. A method for determining a weight-adjusting parameter in predicting water-outburst from coal seam floor by a variable-weight model is provided for the first time. According to engineering demonstration, the parameters determined by the model satisfied the needs of variable-weights can effectively consider the effects of various dominant factor index values under different combined state level conditions, effectively improve the precision of vulnerability assessment and prediction for water-outburst from coal seam floor, and effectively control the variable-weight effects of the factor weights.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE DRAWINGS

FIG. 1 is a flowchart diagram of a method for determining a weight-adjusting parameter in a variable-weight vulnerability assessment method for water-outburst from coal seam floor according to the present invention;

FIG. 2 is a subject diagram for floor limestone water pressure to a coal seam floor aquifuge;

FIG. 3 is a subject diagram for effective aquifuge equivalent thickness of 5# coal seam floor limestone;

FIG. 4 is a subject diagram for thickness of the brittle rock beneath the mining pressing destructing zone of 5# coal seam floor limestone;

FIG. 5 is a subject diagram for wateriness of aquifer of floor limestone;

FIG. 6 is a subject diagram for 5# coal fault scale index;

FIG. 7 is a subject diagram for 5# coal distribution of faults and folds; and

FIG. 8 is a subject diagram for 5# coal distribution of intersection and terminal points of faults and folds.

### DESCRIPTION OF THE PREFERRED EMBODIMENTS

While this invention may be embodied in many different forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

### Embodiment 1

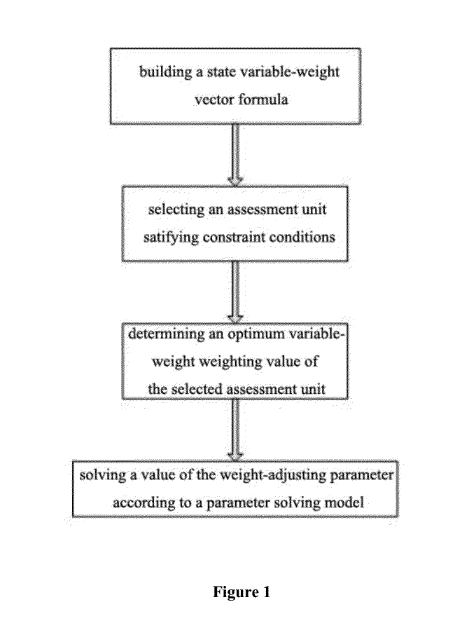

With reference to FIG. 1, a method for determining a weight-adjusting parameter in a variable-weight vulnerability assessment method for water-outburst from coal seam floor according to the present invention comprises the following steps in addition to the determination of dominant factors and constant-weight weighting values:

### 1. Building a State Variable-Weight Vector Formula

The state variable-weight vector formula is built as the following expression:

$${S}_{j} ( x ) = \{ \begin{matrix}{e}^{{a}_{1} ( {d}_{j 1} - x )} + c - 1 , & x ∈ [ 0 , {d}_{j 1} ) \\ c , & x ∈ [ {d}_{1} , {d}_{j 2} ) \\ {e}^{{a}_{2} ( x - {d}_{j 2} )} + c - 1 , & x ∈ [ {d}_{j 2} , {d}_{j 3} ) \\ {e}^{{a}_{3} ( x - {d}_{j 3} )} + {e}^{{a}_{2} ( {d}_{j 3} - {d}_{j 2} )} + c - 2 , & x ∈ [ {d}_{j 3} , 1 ]\end{matrix}$$

wherein the c, a₁, a₂, a₃ are weight-adjusting parameters, and the dⱼ₁, dⱼ₂, dⱼ₃ are the variable-weight interval thresholds of the j^{th} factor.
2. Selecting or Giving an Assessment Unit in Accordance with Constraint Conditions

Under the condition that the variable-weight interval thresholds are known, the selected assessment unit should satisfy the following constraint conditions: the factor indexes are x₁, x₂, x₃, x₄, x₅, x₆, x₇, respectively, wherein the x₁ and x₅ are in a punishing interval, the x₂, x₆, x₇ are in a no-punishing and no-encouraging interval, the x₃ is in a primary encouraging interval, the x₄ is in a strong encouraging interval, and the constant-weight weighting values of the factor (w₁⁰, w₂⁰, w₃⁰, w₄⁰, w₅⁰, w₆⁰, w₇⁰) are known.

### 3. Determining an Optimum Variable-Weight Weighting Value of the Selected Assessment Unit

The determining method may comprise making determination by considering effects of various factor indexes and consulting related experts, or by a decision attitude of the decision maker.

### 4. Solving a Value of the Weight-Adjusting Parameter According to a Parameter Solving Model

The parameter solving model is expressed as follows:

$${a}_{1} = \frac{1}{( {d}_{11} - {x}_{1} )} ln [ \frac{{w}_{1} {w}_{2}^{0} - {w}_{2} {w}_{1}^{0}}{{w}_{2} {w}_{1}^{0}} c + 1 ]$$

$${a}_{2} = \frac{1}{( {x}_{3} - {d}_{32} )} ln [ \frac{{w}_{3} {w}_{2}^{0} - {w}_{2} {w}_{3}^{0}}{{w}_{2} {w}_{1}^{0}} c + 1 ]$$

$${a}_{3} = \frac{1}{( {x}_{4} - {d}_{43} )} ln [ \frac{{w}_{4} {w}_{2}^{0} - {w}_{2} {w}_{4}^{0}}{{w}_{2} {w}_{4}^{0}} c + 2 - {( \frac{{w}_{3} {w}_{2}^{0} - {w}_{2} {w}_{3}^{0}}{{w}_{2} {w}_{3}^{0}} c + 1 )}^{\frac{( {d}_{21} - {d}_{42} )}{( {x}_{3} - {d}_{32} )}} ]$$

$${k}_{1} c = {( {k}_{2} c + 1 )}^{{k}_{3}} - 1 , wherein$$

$${k}_{1} = \frac{{w}_{2}^{0} - {w}_{2}^{0} ( {w}_{1} + {w}_{2} + {w}_{3} + {w}_{4} ) - {w}_{2} ( {w}_{5}^{0} + {w}_{6}^{0} + {w}_{7}^{0} )}{{w}_{2} {w}_{5}^{0}} ;$$

$${k}_{2} = \frac{{w}_{1} {w}_{2}^{0} - {w}_{2} {w}_{1}^{0}}{{w}_{2} {w}_{1}^{0}} ; {k}_{3} = \frac{{d}_{51} - {x}_{5}}{{d}_{1}^{1} - {x}_{1}} ;$$

the x₁, x₂, x₃, x₄, x₅, x₆, x₇ are factor indexes, the d₁₁, d₁₂, d₁₃, d₂₁, d₂₂, d₂₃, . . . , d₇₁, d₇₂, d₇₃ are variable-weight interval thresholds, the w₁⁰, w₂⁰, w₃⁰, w₄⁰, w₅⁰, w₆⁰, w₇⁰ are constant-weight weighting values of the factor, and the w₁, w₂, w₃, w₄, w₅, w₆, w₇ are variable-weight weighting values of the factor.

### Embodiment 2

In view of the present serious problem of water-outburst in a certain mining district and related documents, in the method for determining a weight-adjusting parameter in a variable-weight vulnerability assessment method for water-outburst from coal seam floor according to the present invention, the “constant-weight weighting values” of the dominant factors for the mining district 5# were determined at first:

### 1. Determining the Dominant Factors for Water-Outburst in the Assessment Area and Processing the Data

In view of the hydrogeological condition of the assessment area and in combination of previous assessment experiences, the following 7 factors are selected as the dominant controlling factors to influence water-outburst from limestone floor: (1) effective aquifuge equivalent thickness; (2) thickness of the brittle rock beneath the mining pressing destructing zone; (3) distribution of faults and folds; (4) distribution of intersection and terminal points of faults and folds; (5) fault scale index; (6) wateriness of floor limestone aquifer; and (7) water pressure of floor limestone aquifer.

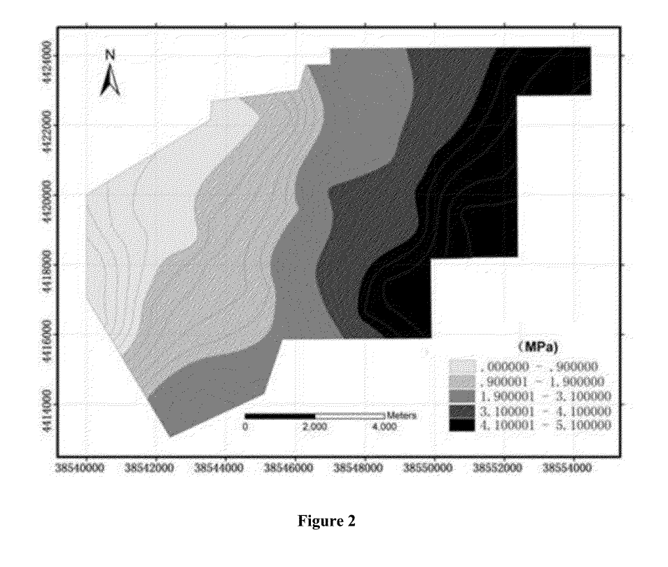

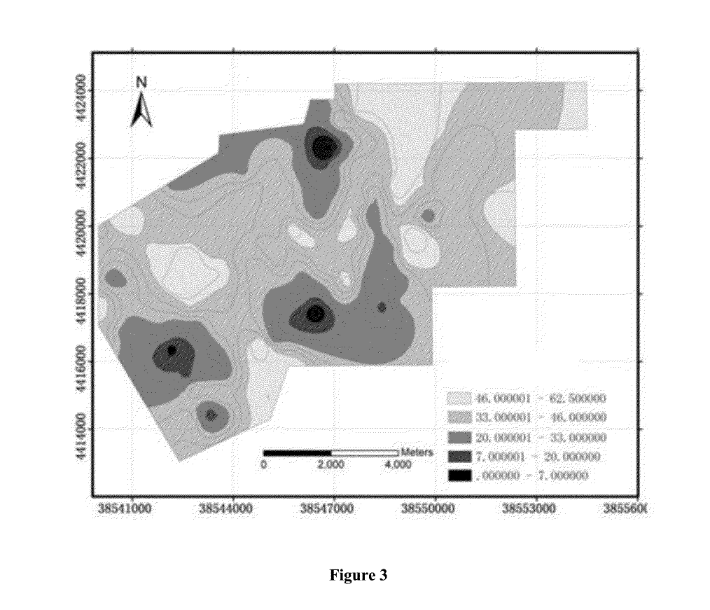

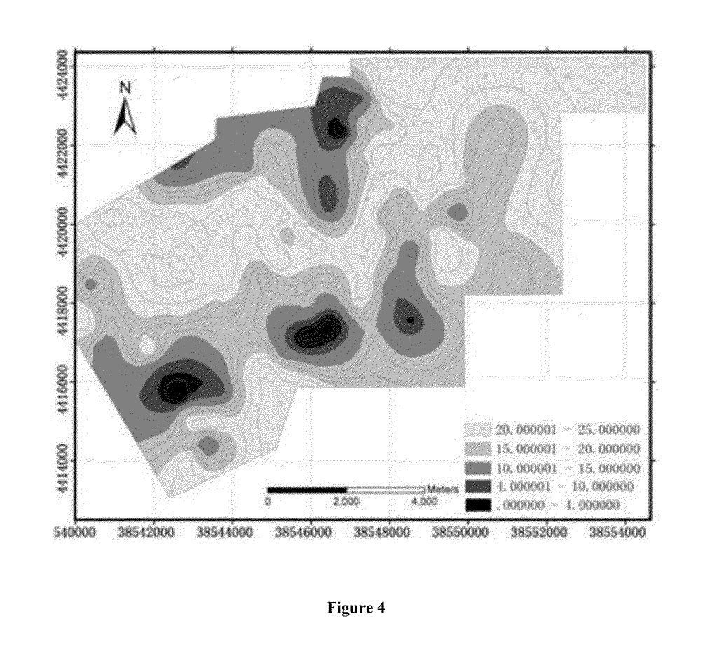

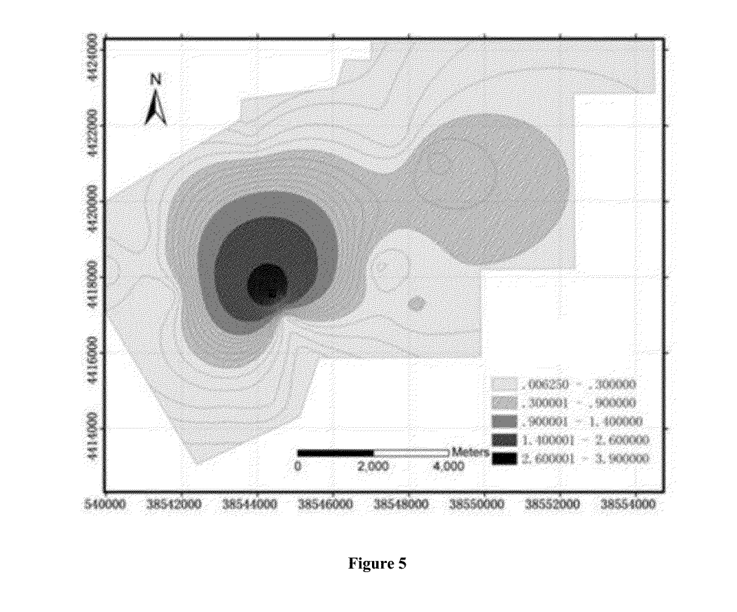

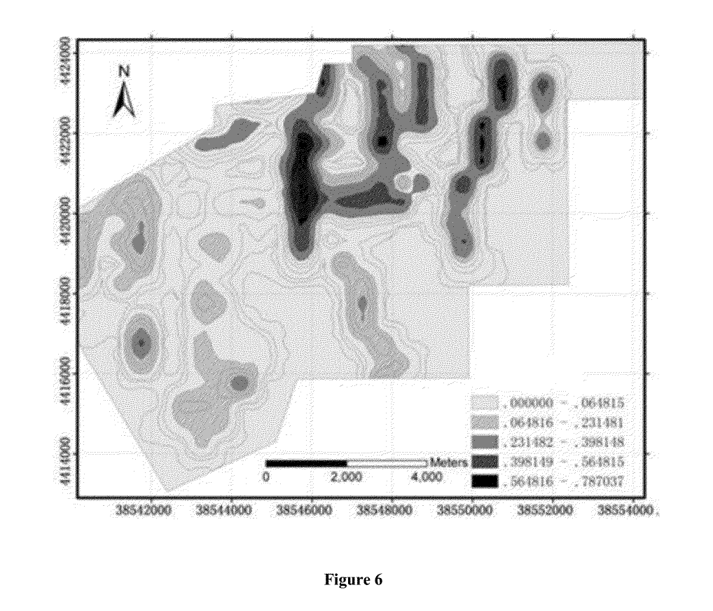

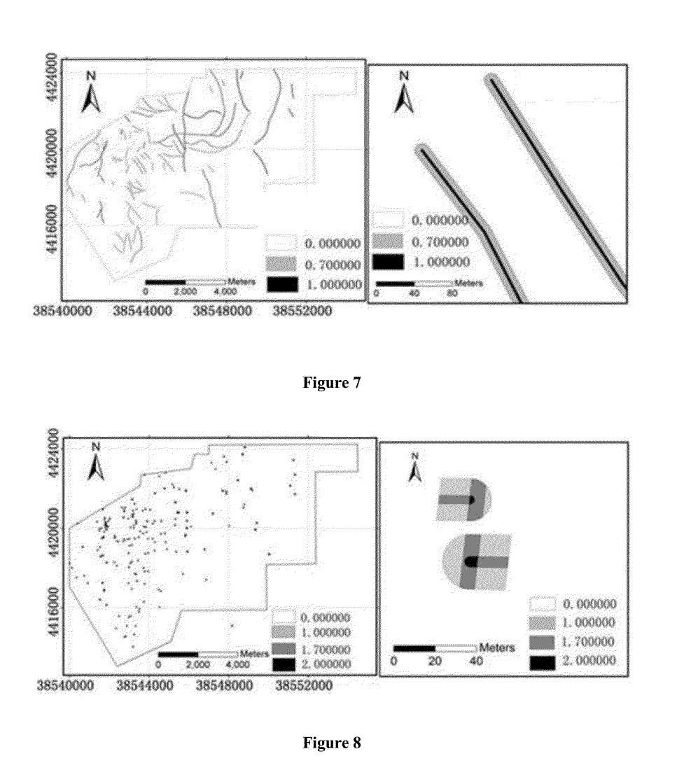

In view of a plenty of hydrogeological exploring drilling and water drawing testing documents for the mining district, raw data of various dominant factors for water-outburst from 5# coal seam floor are collected and processed by interpolation calculation to generate an attribute database and establish subject diagrams for the various dominant factors. The respective subject diagrams formed for the various dominant factors are shown in FIGS. 2-8. Further, the data for individual factors are normalized and then attribute databases for the individual factors can be established.

### 2. Determining the Constant-Weight Weighting Values of the Dominant Factors

In view of analysis to various dominant factors to influence the water-outburst from 5# coal seam floor limestone, the research objects are divided into 3 levels. The final objective for this problem is the vulnerability assessment for water-outburst from limestone floor. With the leveling analyzing method, the finally determined constant-weight weighting values of various dominant factors are shown in Table 1:

TABLE 1
“constant-weight weighting values” of various dominant factors to influence
water-outburst from 5# coal seam floor limestone

| | | thickness of the | | | | | |
|---|---|---|---|---|---|---|---|
| | | brittle rock | | distribution of | | | |
| | aquifuge | beneath the | | intersection | | | |
| | equivalent | mining pressing | distribution | and terminal | | wateriness | water |
| Influencing | thickness | destructing | of faults and | points of faults | fault scale | of aquifer | pressure of |
| factors | (W₁) | zone (W₂) | folds (W₃) | and folds (W₄) | index (W₅) | (W₆) | aquifer (W₇) |
| Weighting | 0.24555 | 0.08185 | 0.16477 | 0.04989 | 0.04534 | 0.13752 | 0.27508 |
| values | | | | | | | |

After determination of the “constant-weight weighting values” of various dominant factors, the method for determining a weight-adjusting parameter in a variable-weight vulnerability assessment method for water-outburst from coal seam floor according to the present invention further comprises the following steps:

### 3. Building a State Variable-Weight Vector Formula

With analysis, the variable-weight intervals for a research area are determined, as shown in Table 2.

TABLE 2
the variable-weight intervals of various dominant factors

| | Natures of variable weight interval | | | |
|---|---|---|---|---|
| | | no-encouraging | primary | strong |
| | punishing | and no-punishing | encouraging | encouraging |
| Dominant factors | interval | interval | interval | interval |
| water pressure | 0.235 > x [symbol] 0 | 0.470 > x [symbol] 0.2352 | 0.705 > x [symbol] 0.47 | 1 [symbol] x [symbol] 0.705 |
| of aquifer | | | | |
| equivalent thickness | 0.534 > x [symbol] 0 | 0.709 > x [symbol] 0.534 | 0.883 > x [symbol] 0.709 | 1 [symbol] x [symbol] 0.883 |
| of coal seam floor | | | | |
| effective aquifuge | | | | |
| thickness of the | 0.676 > x [symbol] 0 | 0.797 > x [symbol] 0.676 | 0.919 [symbol] x [symbol] 0.797 | 1 [symbol] x [symbol] 0.919 |
| brittle rock beneath | | | | |
| the mining pressing | | | | |
| destructing zone | | | | |
| wateriness of | 0.167 > x [symbol] 0 | 0.365 > x [symbol] 0.167 | 0.619 > x [symbol] 0.365 | 1 [symbol] x [symbol] 0.619 |
| aquifer (L/(s · m)) | | | | |
| distribution of faults | | 0.5 > x [symbol] 0 | 0.8 > x [symbol] 0.5 | 1 [symbol] x [symbol] 0.8 |
| distribution of | | 0.5 > x [symbol] 0 | 0.8 > x [symbol] 0.5 | 1 [symbol] x [symbol] 0.8 |
| intersection and | | | | |
| terminal points | | | | |
| of faults | | | | |
| fault scale index | 0.092 > x [symbol] 0 | 0.314 > x [symbol] 0.092 | 0.592 > x [symbol] 0.314 | 1 [symbol] x [symbol] 0.592 |

4. Selecting or Giving an Assessment Unit in Accordance with Constraint Conditions

An evaluation unit is selected in the evaluation area and there are 4 factors in this unit: water pressure of aquifer, fault scale index, effective aquifuge equivalent thickness, and distribution of faults and folds. The index values are in different variable weight intervals wherein the wateriness of aquifer is in the punishing interval, and other index values are in the no-punishing and no-encouraging interval. The index values are shown in the following Table 3.

TABLE 3
index values for the evaluation unit

| Dominant | water pressure | fault scale | effective aquifuge | distribution of |
|---|---|---|---|---|
| factors | of aquifer | index | equivalent thickness | faults and folds |
| Normalized | 0.166 | 0.287 | 0.7555 | 1 |
| index values | | | | |
| | | thickness of the | distribution of | |
| | | brittle rock beneath | intersection and | |
| Dominant | wateriness of | the mining pressing | terminal points of | |
| factors | aquifer | destructing zone | faults and folds | |
| Normalized | 0.017 | 0.72 | 0 | |
| index values | | | | |

### 5. Determining an Optimum Variable-Weight Weighting Value of the Selected Assessment Unit

In consideration of the effects of various factor index values as well as by consulting the related experts, the variable weight weighting values of 7 factors of the assessment unit are determined by means of the leveling analyzing method. The weighting values of the determined variable-weight weighting values of 4 factors of the water pressure of aquifer, fault scale index, effective aquifuge equivalent thickness and distribution of faults and folds, under the state level of this group of index values, are shown in Table 4.

TABLE 4
weighting values of the assessment unit

| | water | fault | effective aquifuge | distribution |
|---|---|---|---|---|
| Dominant | pressure | scale | equivalent | of faults |
| factors | of aquifer | index | thickness | and folds |
| Weighting | 0.258 | 0.04329 | 0.22858 | 0.23049 |
| values | | | | |

It should be noted herein that the formed optimum variable weight weighting values of the 4 factors can be established by a plurality of methods as long as the method is in accordance with actual situation and evaluation preferences of the policy maker.

### 6. Solving a Value of the Weight Adjusting Parameter According to a Parameter Solving Model

We can calculate to obtain: c=1.46, a₁=0.90, a₂=0.90, a₃=1.63.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A method for determining a weight-adjusting parameter in a variable-weight vulnerability assessment method for water-outburst from coal seam floor, comprising the steps of determining a dominant factor and a constant-weight weighting value, characterized in that the method further comprises the following steps:
(1) building a state variable-weight vector formula;
(2) selecting or giving an assessment unit in accordance with constraint conditions;
(3) determining an optimum variable-weight weighting value of the selected assessment unit; and
(4) solving a value of the weight-adjusting parameter according to a parameter solving model.

2. The method for determining a weight-adjusting parameter in a variable-weight vulnerability assessment method for water-outburst from coal seam floor according to claim 1, characterized in that in the step of building a state variable-weight vector formula, the state variable-weight vector formula is expressed as follows:
$${S}_{j} ( x ) = \{ \begin{matrix}{e}^{{a}_{1} ( {d}_{j 1} - x )} + c - 1 , & x ∈ [ 0 , {d}_{j 1} ) \\ c , & x ∈ [ {d}_{1} , {d}_{j 2} ) \\ {e}^{{a}_{2} ( x - {d}_{j 2} )} + c - 1 , & x ∈ [ {d}_{j 2} , {d}_{j 3} ) \\ {e}^{{a}_{3} ( x - {d}_{j 3} )} + {e}^{{a}_{2} ( {d}_{j 3} - {d}_{j 2} )} + c - 2 , & x ∈ [ {d}_{j 3} , 1 ]\end{matrix}$$
Wherein the c, a₁, a₂, a₃ are the weight-adjusting parameters, and the dⱼ₁, dⱼ₂, dⱼ₃ are the variable-weight interval thresholds of the j^{th} factor.

3. The method for determining a weight-adjusting parameter in a variable-weight vulnerability assessment method for water-outburst from coal seam floor according to claim 1, characterized in that in the step of selecting or giving an assessment unit in accordance with constraint conditions, under the condition that the variable-weight interval thresholds are known, the selected assessment unit should satisfy the following constraint conditions: the factor indexes are x₁, x₂, x₃, x₄, x₅, x₆, x₇, respectively, wherein the x₁ and x₅ are in a punishing interval, the x₂, x₆, x₇ are in a no-punishing and no-encouraging interval, the x₃ is in a primary encouraging interval, the x₄ is in a strong encouraging interval, and the constant weight weighting values of the factor (w₁⁰, w₂⁰, w₃⁰, w₄⁰, w₅⁰, w₆⁰, w₇⁰, w₇⁰) are known.

4. The method for determining a weight-adjusting parameter in a variable-weight vulnerability assessment method for water-outburst from coal seam floor according to claim 1, characterized in that in the step of determining an optimum variable weight weighting value of the selected evaluation unit, the determining method comprises consulting related experts and making determination based on a decision attitude of the decision maker.

5. The method for determining a weight-adjusting parameter in a variable-weight vulnerability assessment method for water-outburst from coal seam floor according to claim 1, characterized in that in the step of determining an optimum variable weight weighting value of the selected evaluation unit, the determining method comprises making determination based on a leveling analyzing method.

6. The method for determining a weight-adjusting parameter in a variable-weight vulnerability assessment method for water-outburst from coal seam floor according to claim 1, characterized in that in the step of solving a value of the weight adjusting parameter according to a parameter solving model, the parameter solving model is expressed as follows:
$${a}_{1} = \frac{1}{( {d}_{11} - {x}_{1} )} ln [ \frac{{w}_{1} {w}_{2}^{0} - {w}_{2} {w}_{1}^{0}}{{w}_{2} {w}_{1}^{0}} c + 1 ]$$
$${a}_{2} = \frac{1}{( {x}_{3} - {d}_{32} )} ln [ \frac{{w}_{3} {w}_{2}^{0} - {w}_{2} {w}_{3}^{0}}{{w}_{2} {w}_{3}^{0}} c + 1 ]$$
$${a}_{3} = \frac{1}{( {x}_{4} - {d}_{43} )} ln [ \frac{{w}_{4} {w}_{2}^{0} - {w}_{2} {w}_{4}^{0}}{{w}_{2} {w}_{4}^{0}} c + 2 - {( \frac{{w}_{3} {w}_{2}^{0} - {w}_{2} {w}_{3}^{0}}{{w}_{2} {w}_{3}^{0}} c + 1 )}^{\frac{( {d}_{42} - {d}_{42} )}{( {x}_{3} - {d}_{32} )}} ]$$
$${k}_{1} c = {( {k}_{2} c + 1 )}^{{k}_{3}} - 1 ; wherein$$
$${k}_{1} = \frac{{w}_{2}^{0} - {w}_{2}^{0} ( {w}_{1} + {w}_{2} + {w}_{3} + {w}_{4} ) - {w}_{2} ( {w}_{5}^{0} + {w}_{6}^{0} + {w}_{7}^{0} )}{{w}_{2} {w}_{5}^{0}} ;$$
$${k}_{2} = \frac{{w}_{1} {w}_{2}^{0} - {w}_{2} {w}_{1}^{0}}{{w}_{2} {w}_{1}^{0}} ; {k}_{3} = \frac{{d}_{51} - {x}_{5}}{{d}_{1}^{1} - {x}_{1}} ;$$
the x₁, x₂, x₃, x₄, x₅, x₆, x₇ are factor indexes, the d₁₁, d₁₂, d₁₃, d₂₁, d₂₂, d₂₃, . . . , d₇₁, d₇₂, d₇₃ are variable-weight interval thresholds, the w₁⁰, w₂⁰, w₃⁰, w₄⁰, w₅⁰, w₆⁰, w₇⁰ are constant-weight weighting values of the factor, and the w₁, w₂, w₃, w₄, w₅, w₆, w₇ are variable-weight weighting values of the factor.
